(19) United States
(12) Patent Application Publication
(10) Pub. No.: US 2025/0360424 A1
(43) Pub. Date: Nov. 27, 2025

(54) Method and Systems for Controlling Virtual Vehicles

(71) Applicant: Tencent Technology (Shenzhen) Company Limited, Shenzhen (CN)

(72) Inventor: Ying Deng, Shenzhen (CN)

(21) Appl. No.: 19/293,338

(22) Filed: Aug. 7, 2025

Related U.S. Application Data
(63) Continuation of application No. PCT/CN2024/096036, filed on May 29, 2024.

(30) Foreign Application Priority Data
Aug. 2, 2023 (CN) 2023109698094

(51) Int. Cl. A63F 13/803; A63F 13/52

(52) U.S. Cl. CPC A63F 13/803; A63F 13/52

(57) ABSTRACT

Methods and systems for controlling a virtual vehicle are described herein. Techniques may include displaying a virtual scene, the virtual scene including a virtual vehicle and a skill release control, the skill release control being associated with a plurality of skills, and different skills being triggered in different manners; controlling the virtual vehicle to release a virtual traction apparatus in response to a first trigger operation on the skill release control, one end of the virtual traction apparatus being connected to the virtual vehicle; and controlling, in response to that the other end of the virtual traction apparatus is connected to a first virtual item in the virtual scene, the virtual vehicle to tighten the virtual traction apparatus, to provide auxiliary traction for the virtual vehicle.

### CROSS-REFERENCE TO RELATED APPLICATIONS

This application is a Continuation of PCT Application No. PCT/CN2024/096036, filed May 29, 2024, which claims priority to Chinese Patent Application No. 2023109698094, filed Aug. 2, 2023, each entitled “Method and Apparatus for Controlling Virtual Vehicle, Electronic Device, Computer-Readable Storage Medium, and Computer Program Product” each of which is incorporated by reference in its entirety.

### FIELD

This application relates to the field of computer human-computer interaction technologies, and in particular, to methods and systems for controlling a virtual vehicle.

### BACKGROUND

A display technology based on graphics processing hardware has expanded channels for perceiving an environment and obtaining information. Especially, a display technology of a virtual scene can implement, based on an actual application requirement, diversified interactions between virtual objects that are controlled by users (or players) or artificial intelligence, and has various typical application scenes. For example, in a virtual scene such as a game, an actual battle process between virtual objects can be simulated.

In a related technology, for example, in a mobile game, when a player drives a virtual vehicle (for example, a virtual car) to fall into a large pothole in a virtual scene, the player can only control a virtual object to leave the virtual vehicle by clicking a get-off button first, and then needs to control the virtual object to walk out of the large pothole. It can be learned that this manner is relatively complicated to operate, that is, efficiency of operating the virtual vehicle in the related technology is relatively low. This undoubtedly increases resource overheads of a terminal device during running of the virtual scene.

### SUMMARY

Aspects described herein provide a method and apparatus for controlling a virtual vehicle, an electronic device, a computer-readable storage medium, and a computer program product, to improve efficiency of operating a virtual vehicle in a virtual scene, thereby reducing resource overheads of a terminal device during running of the virtual scene.

Technical solutions of the aspects described herein may be implemented as follows:

An aspect described herein provides a method for controlling a virtual vehicle, performed by an electronic device, including:
displaying a virtual scene, the virtual scene including a virtual vehicle and a skill release control, the skill release control being associated with a plurality of skills, and different skills being triggered in different manners;
controlling the virtual vehicle to release a virtual traction apparatus in response to a first trigger operation on the skill release control, one end of the virtual traction apparatus being connected to the virtual vehicle; and
controlling, in response to that the other end of the virtual traction apparatus is connected to a first virtual item in the virtual scene, the virtual vehicle to tighten the virtual traction apparatus, to provide auxiliary traction for the virtual vehicle.

An aspect described herein provides an apparatus for controlling a virtual vehicle, including:
a display module, configured to display a virtual scene, the virtual scene including a virtual vehicle and a skill release control, the skill release control being associated with a plurality of skills, and different skills being triggered in different manners; and
a control module, configured to control the virtual vehicle to release a virtual traction apparatus in response to a first trigger operation on the skill release control, one end of the virtual traction apparatus being connected to the virtual vehicle; and
the control module being further configured to control, in response to that the other end of the virtual traction apparatus is connected to a first virtual item in the virtual scene, the virtual vehicle to tighten the virtual traction apparatus, to provide auxiliary traction for the virtual vehicle.

An aspect described herein provides an electronic device, including:
a memory, configured to store executable instructions; and
a processor, configured to implement the method for controlling a virtual vehicle according to the aspect described herein when executing the executable instructions stored in the memory.

An aspect described herein provides a computer-readable storage medium, having computer-executable instructions stored therein, which, when executed by a processor, are configured for implementing the method for controlling a virtual vehicle according to the aspect described herein.

An aspect described herein provides a computer program product, including a computer program or computer-executable instructions, which, when executed by a processor, are configured for implementing the method for controlling a virtual vehicle according to the aspect described herein.

The aspects described herein have the following beneficial effects:

When wishing to control the virtual vehicle to release the virtual traction apparatus during driving of the virtual vehicle, a player may reuse an original skill release control in the virtual scene without additionally adding a control, to complete an operation of controlling the virtual vehicle to release the virtual traction apparatus, and auxiliary traction may be provided for the virtual vehicle through the virtual traction apparatus, so as to help the virtual vehicle to drive out of a large pothole in the virtual scene that the virtual vehicle cannot drive out of originally. In this way, compared with a solution provided in a related technology, the technical solution provided in the aspects described herein simplifies operation steps, thereby improving efficiency of operating the virtual vehicle in the virtual scene. This can further reduce the resource overheads of the terminal device during running of the virtual scene.

### BRIEF DESCRIPTION OF THE DRAWINGS

FIG. 1A is a schematic diagram of an application mode of a method for controlling a virtual vehicle according to an aspect described herein.

FIG. 1B is a schematic diagram of an application mode of a method for controlling a virtual vehicle according to an aspect described herein.

FIG. 2 is a schematic structural diagram of an electronic device 500 according to an aspect described herein.

FIG. 3 is a schematic flowchart of a method for controlling a virtual vehicle according to an aspect described herein.

FIG. 4 is a schematic flowchart of a method for controlling a virtual vehicle according to an aspect described herein.

FIG. 5 is a schematic flowchart of a method for controlling a virtual vehicle according to an aspect described herein.

FIG. 6A to FIG. 6C are schematic diagrams of an application scene of a method for controlling a virtual vehicle according to an aspect described herein.

FIG. 7 is a schematic flowchart of a method for controlling a virtual vehicle according to an aspect described herein.

### DETAILED DESCRIPTION

To make the objectives, technical solutions, and advantages described herein clearer, the following describes various aspects in further detail with reference to the accompanying drawings. The described aspects are not to be considered as a limitation to the appended claims. All other aspects obtained by a person of ordinary skill in the art without creative efforts shall fall within the protection scope described herein.

In the following description, the term “some aspects” describes subsets of all possible aspects, but “some aspects” may be the same subset or different subsets of all the possible aspects, and may be combined with each other without conflict.

In aspects described herein, related data (for example, data of virtual objects or virtual vehicles controlled by a user) such as user information is involved. When a specific product or technology is applied to the aspects described herein, permission or consent of a user is required, and collection, use, and processing of the related data need to comply with relevant laws, regulations, and standards.

In the following descriptions, the involved term “first/second/ . . . ” is merely intended to distinguish between similar objects but does not necessarily indicate a specific order of objects. The “first/second/ . . . ” is interchangeable in terms of a specific order or sequence if permitted, so that the aspects described herein described herein can be implemented in a sequence in addition to the sequence shown or described herein.

In the aspects described herein, the term “module” or “unit” refers to a computer program with a predetermined function or a part of the computer program and works, together with other related parts, to implement a predetermined target, and may be completely or partially implemented by software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

Unless otherwise defined, meanings of all technical and scientific terms used herein are the same as those usually understood by a person skilled in the art to which the aspects described herein belong. The terms used herein are merely intended to describe the objectives of the aspects described herein, but are not intended to limit the appended claims.

Before the aspects described herein are further described in detail, a description is made on nouns and terms in the aspects described herein, and the nouns and terms involved in the aspects described herein are applicable to the following explanations.
(1) In response to: The “in response to” is configured for representing a condition or status on which one or more to-be-performed operations depend. When the condition or status is met, the one or more operations may be performed in real time or have a set delay. Unless otherwise specified, there is no chronological order between the plurality of to-be-performed operations.
(2) Virtual scene: The virtual scene is a scene displayed (or provided) when an application runs on a terminal device. The scene may be a simulated environment of a real world, or may be a semi-simulated and semi-fictional virtual environment, or may be a completely fictional virtual environment. The virtual scene may be any one of a two-dimensional virtual scene, a 2.5-dimensional virtual scene, or a three-dimensional virtual scene. A dimension of the virtual scene is not limited in the aspects described herein. For example, the virtual scene may include sky, land, ocean, and the like. The land may include environmental elements such as desert and city, and a user may control a virtual object to move in the virtual scene.
(3) Virtual object: Virtual objects are images of various people and objects that may perform interaction in a virtual scene, or movable objects in the virtual scene. The movable object may be a virtual character, a virtual animal, a cartoon character, or the like, for example, a character or an animal displayed in a virtual scene. The virtual object may be a virtual avatar representing a user in the virtual scene, and may be, for example, a virtual chess piece displayed in a virtual chessboard. The virtual scene may include a plurality of virtual objects, and each virtual object has a shape and a volume in the virtual scene, and occupies some space in the virtual scene.
(4) Scene data: The scene data represents feature data of a virtual scene. For example, the scene data may be an area of a construction region in the virtual scene, a current building style of the virtual scene, and the like; and may also include a position of a virtual building in the virtual scene, an area occupied by the virtual building, and the like.
(5) Virtual vehicle: The virtual vehicle is a virtual prop configured to assist a virtual object in moving in a virtual scene, and may be, for example, a virtual car, a virtual plane, a virtual ship, or a virtual mount in the virtual scene.
(6) Cloud gaming: The cloud gaming is also referred to as gaming on demand, that is, a game program is deployed in a server, an instance (briefly referred to as a game instance) of the game program is run, the game instance transmits game data outputted in a running process to a page of a browser of a user terminal, and the page invokes a media component of the browser to decode the game data, and renders a real-time game picture in a game process according to a decoding result. When monitoring an operation performed by the user in the game picture, the page reports the operation to the game instance running in the server. When game data of a response operation generated by the game instance is received, a decoding and rendering process is repeated, so that a change of the game picture according to the operation of the user is presented on the page.

That is, cloud gaming is an online gaming technology based on a cloud computing technology. The cloud gaming technology enables a thin client with relatively limited graphics processing and data computing capabilities to run high-quality games. In a cloud gaming scene, a game is not run in a user terminal (for example, a player game terminal), but is run in a cloud server, and the cloud server renders the game scene into an audio and video stream and transmits the audio and video stream to the user terminal over a network. In this way, the user terminal does not need to have a strong graphic operation capability and a data processing capability, and only needs to have a basic streaming media playing capability and a capability of obtaining a player input instruction and transmitting the instruction to the cloud server.

Aspects described herein provide a method and apparatus for controlling a virtual vehicle, an electronic device, a computer-readable storage medium, and a computer program product, to improve efficiency of operating a virtual vehicle in a virtual scene, thereby reducing resource overheads of a terminal device. To facilitate an easier understanding of a method for controlling a virtual vehicle according to an aspect described herein, an illustrative implementation scene of the method for controlling a virtual vehicle according to the aspect described herein is first described. The virtual scene in the method for controlling a virtual vehicle according to the aspect described herein may be outputted completely based on a terminal device, or outputted collaboratively based on a terminal device and a server.

In some aspects, the virtual scene may be an environment for game characters to interact. For example, the game characters may battle in the virtual scene, and interaction in the virtual scene may be performed by controlling actions of the game characters, so that the user can relieve the stress in life during the game.

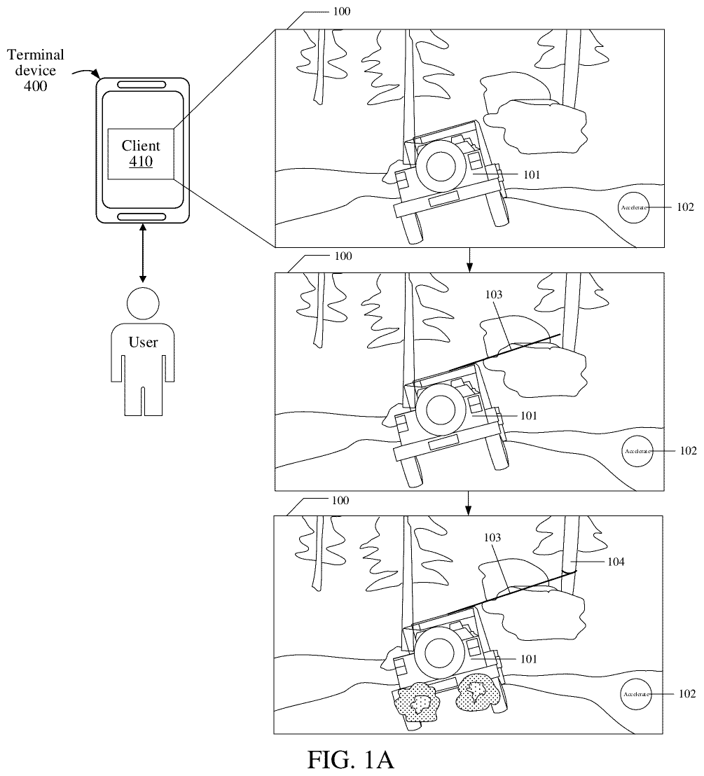

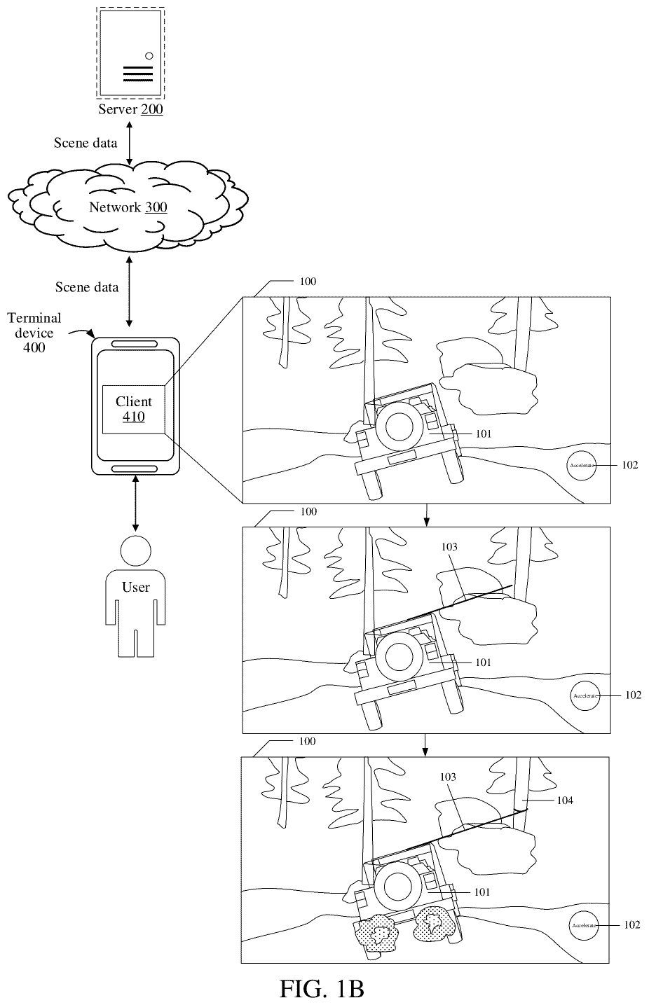

In an implementation scenario, referring to FIG. 1A, FIG. 1A is a schematic diagram of an application mode of an interaction processing method for a virtual scene according to an aspect described herein, which is applicable to some application modes in which calculation of relevant data of a virtual scene 100 is implemented completely relying on a graphics processing hardware computing capability of a terminal device 400, such as a standalone/offline game, and an output of the virtual scene is completed through various types of terminal devices 400 such as a smartphone, a tablet computer, and a virtual reality/augmented reality device.

For example, types of graphics processing hardware includes a central processing unit (CPU) and a graphics processing unit (GPU).

When visual perception of the virtual scene 100 is formed, the terminal device 400 calculates, through graphics computing hardware, data required for display, completes loading, parsing, and rendering of the display data, and outputs, through graphics output hardware, a video frame capable of forming visual perception for the virtual scene. For example, a two-dimensional video frame is presented on a display screen of a smartphone, or a video frame for implementing a three-dimensional display effect is projected on lenses of augmented reality/virtual reality glasses. In addition, to enrich a perception effect, the terminal device 400 may further form one or more of auditory perception, tactile perception, motion perception, and taste perception through different hardware.

As an example, a client 410 (for example, a standalone game application) runs on the terminal device 400. During the running of the client 410, a virtual scene including role-playing is outputted. The virtual scene may be an environment for game characters to interact, and for example, may be a plain, a street, a valley, or the like where game characters battle. For example, a virtual scene 100 may be displayed in a human-computer interaction interface of the client 410. The virtual scene 100 may include a virtual vehicle 101 (for example, a virtual car) and a skill release control 102 (for example, an acceleration button). Then, the client 410 may control the virtual vehicle 101 to release a virtual traction apparatus 103 (for example, a virtual chain), in response to a first trigger operation (for example, a press operation) on the skill release control 102, for example, when the client 410 receives a long press operation performed by a player on an acceleration button. One end of the virtual traction apparatus 103 is connected to the virtual vehicle 101. For example, one end of the virtual chain is fixed to the virtual car. Subsequently, in response to that the other end of the virtual traction apparatus 103 is connected to a first virtual item 104 (for example, a virtual tree 1) with a fixed position in the virtual scene 100, for example, the virtual chain thrown out by the virtual vehicle happens to be tied to the virtual tree 1, the client 410 may control the virtual vehicle 101 to tighten the virtual traction apparatus 103, to provide auxiliary traction for the virtual vehicle 101. For example, the virtual car may accelerate forward with the help of the virtual chain, so that the virtual car can drive through a large pothole in the virtual scene 100 that the virtual car cannot drive through originally.

In another implementation scene, referring to FIG. 1B, FIG. 1B is a schematic diagram of an application mode of a method for controlling a virtual vehicle according to an aspect described herein. The method is applied to a terminal device 400 and a server 200, and is applied to an application mode in which virtual scene calculation is completed depending on a computing capability of the server 200, and a virtual scene is outputted at the terminal device 400.

Using an example in which visual perception of a virtual scene 100 is formed, the server 200 calculates display data (for example, scene data) related to the virtual scene and transmits the display data to the terminal device 400 over a network 300, the terminal device 400 relies on graphics computing hardware to complete loading, parsing, and rendering for the calculated display data, and relies on graphics output hardware to output a virtual scene to form visual perception. For example, a two-dimensional video frame may be presented on a display screen of a smartphone, or a three-dimensional video frame may be projected on lenses of augmented reality/virtual reality glasses. For perception in the form of the virtual scene, an output through corresponding hardware of the terminal device 400 may be used. For example, auditory perception is formed by a microphone, and tactile perception is formed by a vibrator.

As an example, a client 410 (for example, an online game application) runs on the terminal device 400, and performs game interaction with another user through a connection server 200 (for example, a game server). The terminal device 400 outputs a virtual scene 100 of the client 410. The virtual scene 100 may include a virtual vehicle 101 (for example, a virtual car) and a skill release control 102 (for example, an acceleration button). Then, the client 410 may control the virtual vehicle 101 to release a virtual traction apparatus 103 (for example, a virtual chain), in response to a first trigger operation (for example, a press operation) on the skill release control 102, for example, when the client 410 receives a long press operation performed by a player on an acceleration button. One end of the virtual traction apparatus 103 is connected to the virtual vehicle 101. For example, one end of the virtual chain is fixed to the virtual car. Subsequently, in response to that the other end of the virtual traction apparatus 103 is connected to a first virtual item 104 (for example, a virtual tree 1) with a fixed position in the virtual scene 100, for example, the virtual chain thrown out by the virtual vehicle happens to be tied to the virtual tree 1, the client 410 may control the virtual vehicle 101 to tighten the virtual traction apparatus 103, to provide auxiliary traction for the virtual vehicle 101. For example, the virtual car may accelerate forward with the help of the virtual chain, so that the virtual car can drive through a large pothole in the virtual scene 100 that the virtual car cannot drive through originally.

A solution for cooperative implementation of the terminal device and the server mainly involves two gaming modes, namely a local gaming mode and a cloud gaming mode. The local gaming mode means that the terminal device and the server cooperatively run game processing logic. Some operation instructions inputted by a player into the terminal device are used by the terminal device to run game logic processing, and some other operation instructions are used by the server to run game logic processing. In addition, the game logic processing run by the server is usually more complex and needs to consume more computing power. The cloud gaming mode means that game logic processing is completely run by the server (for example, a cloud server), the cloud server renders game scene data into audio and video streams, and then the audio and video streams are transmitted to the terminal device over a network to be displayed. That is, the terminal device only needs to have a basic streaming media playing capability and a capability of obtaining an operation instruction of a player and transmitting the operation instruction to the server.

In some aspects, the terminal device 400 may implement the method for controlling a virtual vehicle according to the aspect described herein by running various computer-executable instructions or a computer program. For example, the computer-executable instructions may be microprogram-level commands, machine instructions, or software instructions. For example, the computer program may be a native program or software module in an operating system, or may be a native application (APP), namely a program that needs to be installed on the operating system to run, such as an adventure game APP (namely the above-mentioned client 410), or may be a mini program, namely a program that can be run only by downloading the program into a browser environment, or may be a game mini program that can be embedded in any APP. To sum up, the computer program may be any form of an application, a module, or a plug-in.

Taking the computer program being an application as an example, in actual implementation, the terminal device 400 installs and runs an application that supports a virtual scene. The application may be any one of a multiplayer strategy game, a virtual reality application, a three-dimensional map program, an adventure game, a massively multiplayer online role-playing game, or a multiplayer gunfight survival game. A user uses the terminal device 400 to operate a virtual object in a virtual scene to perform an action. The action includes, but is not limited to, at least one of body posture adjustment, crawling, walking, running, cycling, jumping, driving, picking, shooting, attacking, throwing, and building of a virtual building. Illustratively, the virtual object may be a virtual character, such as a simulated character or a cartoon character.

In some other aspects, the aspects described herein may alternatively be implemented by a cloud technology. The cloud technology is a hosting technology that unifies a series of resources such as hardware, software, and networks in a wide area network or a local area network to implement computing, storage, processing, and sharing of data.

The cloud technology is a general term for a network technology, an information technology, an integration technology, a management platform technology, an application technology, and the like that are applied based on a cloud computing business model. The technologies can form a resource pool to be flexibly used on demand. A cloud computing technology becomes important support. A backend service of a technical network system needs a large quantity of computing and storage resources.

Illustratively, the server 200 in FIG. 1 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal device 400 may be a smartphone, a tablet computer, a notebook computer, a desktop computer, a smart speaker, a smartwatch, an in-vehicle terminal, a virtual reality device, an augmented reality device, or the like, but is not limited thereto. The terminal device 400 and the server 200 may be directly or indirectly connected through wired or wireless communication. This is not limited in the aspect described herein.

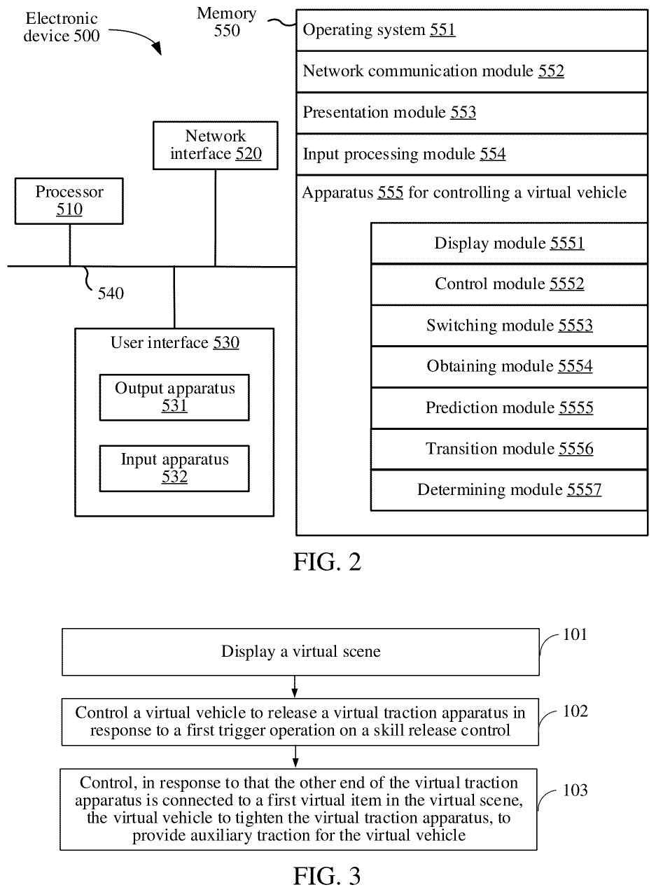

A structure of an electronic device according to an aspect described herein is described below. Taking the electronic device being a terminal device as an example, referring to FIG. 2, FIG. 2 is a schematic structural diagram of an electronic device 500 according to an aspect described herein. The electronic device 500 shown in FIG. 2 includes at least one processor 510, a memory 550, at least one network interface 520, and a user interface 530. Components in the electronic device 500 are coupled together by a bus system 540. The bus system 540 is configured to implement connection and communication between these components. In addition to a data bus, the bus system 540 further includes a power bus, a control bus, and a status signal bus. However, for ease of clear description, various buses are marked as the bus system 540 in FIG. 2.

The processor 510 may be an integrated circuit chip, and has a signal processing capability, for example, a general-purpose processor, a digital signal processor (DSP), another programmable logic device, a discrete gate or transistor logic device, or a discrete hardware component. The general-purpose processor may be a microprocessor, any conventional processor, or the like.

The user interface 530 includes one or more output apparatuses 531 that enable presentation of media content, including one or more speakers and/or one or more visual display screens. The user interface 530 further includes one or more input apparatuses 532, including a user interface component helping a user input, for example, a keyboard, a mouse, a microphone, a touch display screen, a camera, or another input button and control.

The memory 550 may be a removable memory, a non-removable memory, or a combination thereof. Illustrative hardware devices include a solid state memory, a hard disk drive, an optical disk drive, and the like. In some aspects, the memory 550 may include one or more storage devices that are physically away from the processor 510.

The memory 550 includes a volatile memory or a non-volatile memory, or may include both a volatile memory and a non-volatile memory. The non-volatile memory may be a read-only memory (ROM), and the volatile memory may be a random-access memory (RAM). The memory 550 described in the aspects described herein is intended to include any appropriate type of memories.

In some aspects, the memory 550 can store data to support various operations. Examples of the data include a program, a module, and a data structure, or a subset or a superset thereof, which are illustratively described below.

An operating system 551 includes system programs for processing various basic system services and performing hardware-related tasks, for example, a framework layer, a kernel library layer, and a driver layer, which are configured for implementing various basic services and processing hardware-based tasks.

A network communication module 552 is configured to connect to another computer device through one or more (wired or wireless) network interfaces 520. The illustrative network interfaces 520 include Bluetooth, wireless fidelity (Wi-Fi), a universal serial bus (USB), and the like.

A presentation module 553 is configured to enable presentation of information through one or more output apparatuses 531 (for example, a display screen and a speaker) associated with the user interface 530 (for example, a user interface for operating a peripheral device and displaying content and information).

An input processing module 554 is configured to detect one or more user inputs or interactions from one of one or more input apparatuses 532 and translate a detected input or interaction.

In some aspects, an apparatus according to an aspect described herein may be implemented in a software manner. FIG. 2 shows an apparatus 555 for controlling a virtual vehicle, which is stored in a memory 550. The apparatus may be software in a form of a program, a plug-in, or the like, and includes the following software modules: a display module 5551, a control module 5552, a switching module 5553, an obtaining module 5554, a prediction module 5555, a transition module 5556, and a determining module 5557. These modules are logical modules, and therefore may be arbitrarily combined or further split according to functions to be implemented. For ease of expression, all the foregoing modules are shown at a time in FIG. 2. However, the apparatus 555 for controlling a virtual vehicle is not to be considered as excluding implementations that may include only the display module 5551 and the control module 5552. Functions of the modules are described in the following.

The following specifically describes, with reference to the illustrative application and implementation of the terminal device provided in the aspects described herein, the method for controlling a virtual vehicle according to the aspect described herein.

For example, referring to FIG. 3, FIG. 3 is a schematic flowchart of a method for controlling a virtual vehicle according to an aspect described herein. Descriptions are given below with reference to operations shown in FIG. 3.

The method shown in FIG. 3 may be performed by various forms of computer programs run by a terminal device, is not limited to a client, and for example, may alternatively be the operating system, the software module, the script, and the mini program described above. Therefore, the following examples of the client are not to be considered as a limitation on the aspects described herein. In addition, for ease of description, the terminal device and the client running on the terminal device are not specifically distinguished in the following.

Operation 101: Display a virtual scene.

Herein, the virtual scene may include a virtual vehicle (for example, a virtual car) and a skill release control (for example, an acceleration button associated with the virtual car). The skill release control may be associated with a plurality of skills, and different skills are triggered in different manners. Taking the skill release control being an acceleration button as an example, when a press operation (namely a first trigger operation) performed by a player on the acceleration button is received, the virtual vehicle may be controlled to release a virtual traction apparatus (for example, a virtual chain); and when a click operation (namely a second trigger operation) performed by the player on the acceleration button is received, the virtual vehicle may be controlled to accelerate forward. In this way, by reusing of the original acceleration button in the virtual scene, an operation of controlling the virtual vehicle to release the virtual chain (namely a grappling operation) can be implemented without additionally adding a new button, to provide auxiliary traction for the virtual vehicle, so as to help the virtual vehicle drive out of some areas in the virtual scene that the virtual vehicle cannot drive out of originally, thereby improving game experience of the player.

In some aspects, operation 101 may be implemented in the following manner: A virtual scene is displayed, where the virtual scene includes a virtual object (for example, a game character A controlled by a player) and a vehicle control (for example, a vehicle button); and a virtual vehicle and a skill release control are displayed in the virtual scene, and the virtual object is controlled to enter the virtual vehicle, in response to a trigger operation on the vehicle control.

Taking a client being a massively multiplayer online role-playing game APP an example, the massively multiplayer online role-playing game APP runs on a terminal device (for example, a mobile phone) associated with a player. When a click operation performed by the player on an APP icon is received, a virtual scene may be displayed on a screen of the terminal device. The virtual scene may include a game character A controlled by the player and a vehicle button. When a click operation performed by the player on the vehicle button is received, a virtual car (a get-on button may also be displayed near the virtual car) and an acceleration control may be displayed in the virtual scene. Subsequently, the game character A may be controlled to automatically enter the virtual car, or when a click operation performed by the player on the get-on button is received, the game character A is controlled to enter the virtual car. In addition, when a click operation performed by the player on the acceleration button is received, the virtual car may be controlled to accelerate forward.

A joystick control (for example, a virtual joystick button) may also be displayed in the virtual scene, and the player may further control a driving direction of the virtual car in the virtual scene by shaking the joystick control, and for example, may control the virtual car to move forward, move backward, turn left, or turn right.

In some aspects, the virtual scene may be displayed in the human-computer interaction interface of the client from a first-person perspective (for example, a virtual object in a game is played from a perspective of the user), or the virtual scene may be displayed from a third-person perspective (for example, the user runs after a virtual object in the game to play the game), or the virtual scene may be displayed from a bird's large eye view. The foregoing different perspectives may be arbitrarily switched.

As an example, the virtual object may be an object controlled by a current user in a game. Certainly, the virtual scene may further include another virtual object, for example, a virtual object that may be controlled by another user or controlled by a robot program. The virtual object may be grouped into any one of a plurality of teams, there may be an enemy relationship or a cooperative relationship between teams, and the teams in the virtual scene may include one or all of the foregoing relationships.

Taking display of a virtual scene from the first-person perspective as an example, displaying a virtual scene in the human-computer interaction interface may include: determining a view field area of a virtual object based on a viewing position and a view field angle of the virtual object in a complete virtual scene, and presenting a part, which is in the view field area, of the complete virtual scene. That is, the displayed virtual scene may be a part of the virtual scene relative to a panoramic virtual scene. Because the first-person perspective is a viewing perspective that can give a user the greatest impact, immersive perception of the user being immersive in an operation process can be implemented.

Taking a virtual scene being displayed from the bird's large eye view as an example, displaying a virtual scene in the human-computer interaction interface may include: presenting, in response to a zooming operation on a panoramic virtual scene, a part of the virtual scene corresponding to the zooming operation in the human-computer interaction interface. That is, the displayed virtual scene may be a part of the virtual scene relative to the panoramic virtual scene. In this way, operability of the user during the operation process can be improved, thereby improving efficiency of human-computer interaction.

Operation 102: Control the virtual vehicle to release a virtual traction apparatus in response to a first trigger operation on the skill release control.

In some aspects, the first trigger operation may be a press operation (for example, a long press operation), and then operation 102 may be implemented in the following manner: The skill release control is switched to a wheel control in response to the press operation on the skill release control; and the virtual vehicle is controlled to release the virtual traction apparatus in a first direction in the virtual scene in response to a drag operation on the wheel control, where the first direction is a direction indicated by the wheel control when the drag operation is released.

The long press operation in the aspect described herein is an operation in which pressing duration reaches a duration threshold (for example, 3 seconds).

Taking the skill release control being an acceleration button as an example, when a long press operation performed by the player on the acceleration button is received, the acceleration button may be re-presented in a wheel form (that is, the acceleration button is switched to a wheel button). The wheel button may include a large circle and a small circle. The player may drag the small circle in the large circle, to control a release direction of a virtual traction apparatus (for example, a virtual chain) on the virtual vehicle in the virtual scene. That is, the player may select a virtual item (for example, a virtual tree or a virtual boulder) around the virtual vehicle by dragging the wheel button. When the client detects that the drag operation is released (that is, the player releases the operation), the virtual vehicle may be controlled to release the virtual chain in a direction (namely the first direction) currently indicated by the wheel control, to tie the virtual chain to a virtual item that is in the first direction and that is closest to the virtual vehicle.

In addition to the virtual chain, the virtual traction apparatus in the aspect described herein may alternatively be a virtual pulley apparatus, or the like. This is not specifically limited in the aspect described herein. In addition, in addition to the acceleration button, the skill release control in the aspect described herein may alternatively be a projectile button, a turning button, or the like. That is, any original button in the virtual scene may be reused in the aspect described herein. This is not specifically limited in the aspect described herein.

In some other aspects, the virtual vehicle may be located in a first pothole zone (for example, a large pothole zone in the virtual scene) in the virtual scene. The first pothole zone is an area in the virtual scene that the virtual vehicle cannot drive out of based on traction of the virtual vehicle. For example, a slip coefficient of the virtual vehicle in the first pothole zone is less than a resistance coefficient, and as a result, the virtual vehicle cannot drive out of the first pothole zone based on the traction of the virtual vehicle. Therefore, for a case that a release direction of the virtual traction apparatus is determined by the wheel control, when the virtual vehicle drives out of the first pothole zone with the help of the virtual traction apparatus, the following processing may be further performed: The wheel control displayed in the virtual scene is switched back to the skill release control.

The slip coefficient refers to a ratio of a friction between a tire and a ground to a maximum tire grip. A lower slip coefficient indicates a stronger tire grip and more stable driving of the virtual vehicle.

Taking the first pothole zone being a large pothole zone in the virtual scene as an example, when it is detected that the virtual vehicle drives out of the large pothole zone with the help of a virtual traction apparatus (for example, a virtual chain), the virtual vehicle does not need the help of the virtual traction apparatus. Therefore, the client may switch the wheel control back to the skill release control (for example, the acceleration button), and for example, may automatically switch the wheel control back to the acceleration button 5 seconds after it is detected that the virtual vehicle drives out of the large pothole zone. That is, a wheel style may be restored to the acceleration button.

In some aspects, the following processing may be further performed: First prompt information is displayed in response to that the virtual vehicle drives into the first pothole zone, the first prompt information being configured for prompting that the virtual vehicle falls into the first pothole zone; and second prompt information is displayed in response to that the virtual vehicle drives out of the first pothole zone with the help of the virtual traction apparatus, the second prompt information being configured for prompting that the virtual vehicle successfully drives out of the first pothole zone.

Taking the first pothole zone being a mud pit as an example, to determine whether a player falls into the mud pit during driving of the virtual vehicle, a flag on whether the virtual vehicle is in the mud pit may be arranged on a body of the virtual vehicle. When a map of the virtual scene is made, a movement trigger is added to the mud pit. A mud pit entry notification is triggered when the virtual vehicle moves into the mud pit, and an exit notification is triggered when the virtual vehicle drives out of the mud pit. In this way, according to the entry/exit notification, the flag on whether the virtual vehicle is in the mud pit may be synchronously modified, and an interface interaction prompt is synchronously triggered. For example, when the virtual vehicle drives into the mud pit, prompt information (namely first prompt information) prompting that the vehicle falls into the pit may be displayed. When the virtual vehicle drives out of the mud pit, prompt information (namely second prompt information) prompting that the vehicle successfully drives out may be displayed. In this way, the player may visually learn whether the virtual vehicle is currently in the mud pit, to determine whether the virtual vehicle needs to be controlled to release the virtual traction apparatus. This can provide reference for subsequent decision by the player.

In some other aspects, the virtual scene may further include a joystick control, and after the skill release control is switched to the wheel control, the following processing may be further performed: In response to a shaking operation on the joystick control, a virtual lens in the virtual scene is controlled to translate in a shaking direction of the shaking operation. For example, when the player shakes the joystick control leftward, the virtual lens in the virtual scene may be controlled to translate leftward, so as to help the player check whether there is a virtual item on a left side of the virtual vehicle, for example, help the player check whether there is a virtual tree, a virtual boulder, or the like on the left side of the virtual car.

Taking the skill release control being an acceleration button as an example, when a long press operation performed by a player on the acceleration button is received, the acceleration button may be re-presented in a wheel form, to represent that an auxiliary mode (or a chain mode) is currently entered. In this case, if the player operates the joystick control with the left hand, a shaking operation on the joystick control is changed to an operation of assisting a lens in translation. For example, when the player shakes the joystick control leftward, the virtual lens in the virtual scene may be controlled to translate leftward, or when the player shakes the joystick control rightward, the virtual lens may be controlled to translate rightward, so as to help the player check whether there is a virtual tree, a virtual boulder, or the like nearby.

In some aspects, the first trigger operation may be a press operation (for example, a long press operation), and operation 102 may alternatively be implemented in the following manner: The virtual vehicle is controlled to release the virtual traction apparatus in a second direction in the virtual scene in response to the press operation on the skill release control, where the second direction may include one of the following: a current driving direction of the virtual vehicle, a direction pointing from the virtual vehicle to a closest virtual item, and a direction pointing from the virtual vehicle to a virtual item with a maximum tolerance.

Taking the skill release control being an acceleration button as an example, when a long press operation performed by a player on the acceleration button is received, a current driving direction (for example, a direction 1) of the virtual vehicle may be obtained, and the virtual vehicle may be controlled to automatically release a virtual traction apparatus in the direction 1 in the virtual scene. For example, the virtual vehicle may be controlled to automatically throw a virtual chain in the direction 1 in the virtual scene, to tie the other end of the virtual chain to a virtual item that is in the direction 1 and that is closest to the virtual vehicle.

Taking the skill release control being an acceleration button as an example, when a long press operation performed by a player on the acceleration button is received, a virtual item (for example, a virtual item 1) that is closest to the virtual vehicle and that is in the virtual scene may be obtained, and then the virtual vehicle may be controlled to release a virtual traction apparatus in a direction of the virtual item 1. For example, the virtual vehicle may be controlled to automatically throw a virtual chain in a direction of the virtual item 1, to tie the other end of the virtual chain to the virtual item 1.

Taking the skill release control being an acceleration button as an example, when a long press operation performed by a player on the acceleration button is received, a virtual item (for example, a virtual item 2) that is within a connection range of a virtual traction apparatus (for example, a virtual chain) and that has a maximum tolerance in a virtual scene may be obtained, and then the virtual vehicle may be controlled to automatically throw the virtual chain in a direction of the virtual item 2, to tie the other end of the virtual chain to the virtual item 2.

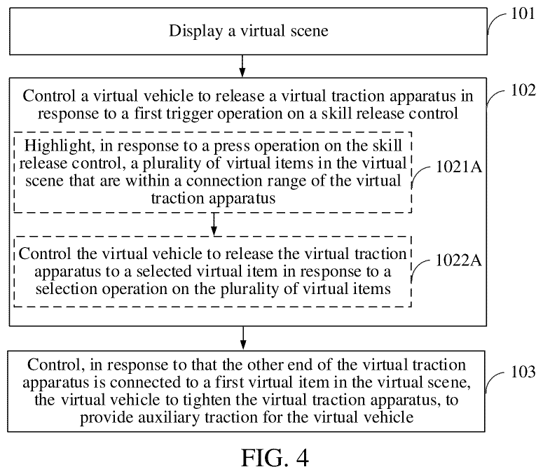

In some other aspects, the first trigger operation may be a press operation, and operation 102 shown in FIG. 3 may be implemented by operation 1021A and operation 1022A shown in FIG. 4, and description is given with reference to operations shown in FIG. 4.

Operation 1021A: Highlight, in response to the press operation on the skill release control, a plurality of virtual items in the virtual scene that are within a connection range of the virtual traction apparatus.

In some aspects, taking the skill release control being an acceleration button as an example, when a long press operation performed by a player on the acceleration button is received, a plurality of virtual items in a virtual scene that are within a connection range of a virtual traction apparatus (for example, a virtual chain) may be highlighted. For example, the plurality of virtual items within the connection range of the virtual chain may be highlighted, to remind the player.

The position of the virtual item in the aspect described herein in the virtual scene may be fixed. For example, the virtual item may be a tree, a boulder, or the like in the virtual scene. Certainly, the position of the virtual item in the virtual scene may alternatively vary. For example, the virtual item may be another virtual vehicle in the virtual scene, for example, a virtual car driven by another player. This is not specifically limited in the aspect described herein.

Operation 1022A: Control the virtual vehicle to release the virtual traction apparatus to a selected virtual item in response to a selection operation on the plurality of virtual items.

In some aspects, following the foregoing example, after a plurality of virtual items (including, for example, a tree and a stone in the virtual scene) in the virtual scene that are within a connection range of the virtual traction apparatus is highlighted, a player may make a selection on the plurality of virtual items. For example, when a click operation performed by the player on a virtual item 1 among the plurality of virtual items is received, the virtual item 1 may be used as a selected virtual item, and the virtual vehicle may be controlled to release the virtual traction apparatus to the virtual item 1. For example, the virtual vehicle may be controlled to throw a virtual chain to the virtual item 1, to tie the other end of the virtual chain to the virtual item 1.

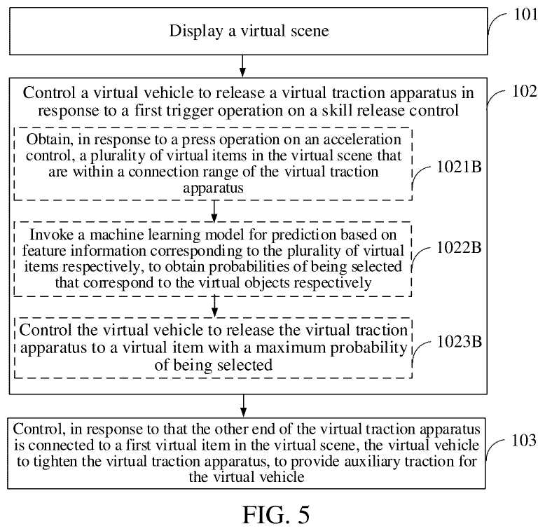

In some aspects, the first trigger operation may be a press operation, the skill release control may be an acceleration control, and operation 102 shown in FIG. 3 may be implemented by operation 1021B to operation 1023B shown in FIG. 5. Description is given with reference to operations shown in FIG. 5.

Operation 1021B: Obtain, in response to the press operation on the acceleration control, a plurality of virtual items in the virtual scene that are within a connection range of the virtual traction apparatus.

In some aspects, taking the virtual traction apparatus being a virtual chain as an example, when a long press operation performed by a player on the acceleration control is received, a plurality of virtual items in the virtual scene that are within a connection range of the virtual chain may be obtained. For example, assuming that the virtual chain has a length of 20 meters, a plurality of virtual items in the virtual scene that are within a semi-circle with the virtual vehicle as a circle center and a radius of 20 meters and corresponding to a driving direction of the virtual vehicle may be obtained.

Operation 1022B: Invoke a machine learning model for prediction based on feature information corresponding to the plurality of virtual items respectively, to obtain probabilities of being selected that correspond to the virtual items respectively.

In some aspects, after the plurality of virtual items in the virtual scene that are within the connection range of the virtual traction apparatus are obtained, a trained machine learning model may be invoked for prediction based on feature information (including, for example, a distance between the virtual items and the virtual vehicle, an orientation relationship, and a tolerance of the virtual items) corresponding to the plurality of virtual items respectively, to obtain probabilities of being selected that correspond to the virtual items respectively.

In some other aspects, before the machine learning model is invoked for prediction, the following processing may be further performed: a sample virtual item is obtained; an initialized machine learning model is invoked for prediction based on feature information of the sample virtual item, to obtain a prediction result; and a difference (namely an error) between the prediction result and marked data is determined, backpropagation is performed based on the difference, and parameters of the machine learning model are updated layer by layer in a backpropagation process, where the marked data includes a probability of being selected that is pre-marked for the sample virtual item.

The backpropagation (BP) is the abbreviation of “error backpropagation”, and is a method used in combination with an optimization method (such as a gradient descent method) to train a machine learning model. According to the method, a gradient of a loss function is calculated for all weights in the model, and the gradient is fed back to the optimization method to update a weight to minimize the loss function. A learning process of the backpropagation includes a forward propagation process and a backpropagation process. In the forward propagation process, input information passes through an input layer and a hidden layers, is processed layer by layer, and is transmitted to an output layer. If a desired output value cannot be obtained at the output layer, a quadratic sum of the output value and a desired error is used as a target function, and backpropagation is performed. A partial derivative of the target function for a weight of each neuron is obtained layer by layer, to form a gradient of the target function for a weight vector, as a basis for modifying the weight. Learning of a network is completed in a weight modification process. When the error reaches a desired value, the network learning ends.

For example, the illustrative structure of the machine learning model provided in the aspect described herein may include an input layer (namely an embedding layer), an encoding layer (which may include, for example, a plurality of cascaded convolutional layers), a fully connected layer, and an output layer (including an activation function such as a Softmax function). After a sample virtual item is obtained, feature information of the sample virtual item may be first inputted into the input layer to be embedded. Then, an embedding feature vector outputted by the input layer may be encoded through the encoding layer, to obtain a hidden layer feature vector. Then the hidden layer feature vector is fully connected through the fully connected layer. Finally, a full connection result outputted by the fully connected layer is inputted into the output layer, to cause the output layer to perform activation, so as to obtain a prediction result. After the prediction result is obtained, the prediction result and the probability of being selected that is pre-marked for the sample virtual item may be substituted into the loss function, to obtain a corresponding difference, and backpropagation may be performed based on the difference, so that the parameters of the machine learning model may be updated layer by layer in the backpropagation process, to obtain a trained machine learning model.

The machine learning model in the aspect described herein may be a neural network model (for example, a convolutional neural network, a deep convolutional neural network, or a fully connected neural network), a decision tree model, a gradient boosting tree, a multilayer perceptron, a support vector machine, or the like. The type of the machine learning model is not specifically limited in the aspect described herein.

Operation 1023B: Control the virtual vehicle to release the virtual traction apparatus to a virtual item with a maximum probability of being selected.

In some aspects, taking the plurality of virtual items being 5 virtual items as an example, it is assumed that the virtual items are a virtual tree 1, a virtual rock 1, a virtual tree 2, a virtual tree 3, and a virtual rock 2. It is assumed that a probability of being selected corresponding to the virtual tree 1 is 80%, a probability of being selected corresponding to the virtual rock 1 is 83%, a probability of being selected corresponding to the virtual tree 2 is 87%, a probability of being selected corresponding to the virtual tree 3 is 78%, and a probability of being selected corresponding to the virtual rock 2 is 95%. That is, the probability of being selected corresponding to the virtual rock 2 is a maximum, and the virtual vehicle may be controlled to release a virtual traction apparatus to the virtual rock 2. For example, the virtual vehicle may be controlled to throw a virtual chain to the virtual rock 2, to tie the other end of the virtual chain to the virtual rock 2. That is, after a long press operation performed by the player on the acceleration control is detected, the virtual vehicle may be controlled to automatically release the virtual traction apparatus to a virtual item with a maximum probability of being selected.

Operation 103: Control, in response to that the other end of the virtual traction apparatus is connected to a first virtual item in the virtual scene, the virtual vehicle to tighten the virtual traction apparatus, to provide auxiliary traction for the virtual vehicle.

In some aspects, taking the virtual traction apparatus being a virtual chain an example, one end of the virtual chain is connected to the virtual vehicle. When a first trigger operation (for example, a press operation) performed by a player on a skill release control (for example, an acceleration button) is received, the virtual vehicle may be controlled to throw the virtual chain into the virtual scene. When the other end of the virtual chain is connected to a first virtual item (for example, a virtual tree 1) with a fixed position in the virtual scene, for example, assuming that the virtual chain thrown by the virtual vehicle happens to be tied to the virtual tree 1 in the virtual scene, the virtual vehicle may be controlled to tighten the virtual chain, thereby providing auxiliary traction for the virtual vehicle.

In some other aspects, in response to that the other end of the virtual traction apparatus is connected to the first virtual item in the virtual scene, the following processing may be further performed: The first virtual item is highlighted; and the first virtual item is restored to a default display style and a second virtual item in the virtual scene is highlighted, in response to that the other end of the virtual traction apparatus is switched to being connected to the second virtual item.

Taking the virtual traction apparatus being a virtual chain as an example, when it is detected that the other end of the virtual chain is currently connected to a first virtual item (for example, a virtual tree 1) in a virtual scene, the virtual tree 1 may be highlighted. For example, the virtual tree 1 may be highlighted, to prompt a player that the virtual chain is currently tied to the virtual tree 1. When it is detected that the other end of the virtual chain is switched to being connected to a second virtual item (for example, a virtual tree 2) in the virtual scene, for example, when a drag operation performed by the player on the wheel control is received, or the player reselects the virtual tree 2 from a plurality of virtual items, the virtual tree 1 may be restored to a default display style, and the virtual tree 2 is highlighted. For example, the virtual tree 2 may be highlighted, to represent that the virtual chain is currently switched to being tied to the virtual tree 2.

In some aspects, a planner may further pre-configure tolerances of virtual items included in the virtual scene. That is, each virtual item in the virtual scene may further include a corresponding tolerance (namely a maximum pulling force that the virtual item can bear without being damaged). Therefore, before the virtual vehicle is controlled to tighten the virtual traction apparatus, the following processing may be further performed: A tolerance of a first virtual item is obtained; and in response to that the tolerance is greater than or equal to the auxiliary traction, switching is performed to executing the process of controlling the virtual vehicle to tighten the virtual traction apparatus.

Taking the first virtual item being a virtual tree as an example, to prevent the virtual tree from being broken, before the virtual vehicle is controlled to tighten a virtual traction apparatus (for example, a virtual chain), a tolerance of the virtual tree may alternatively be obtained first, that is, a maximum pulling force that the virtual tree can bear without breaking is obtained. When the maximum pulling force that the virtual tree can bear is greater than or equal to auxiliary traction, the virtual vehicle may be controlled to tighten the virtual chain, to provide the auxiliary traction for the virtual vehicle, so as to help the virtual vehicle drive out of an area in the virtual scene that the virtual vehicle cannot drive out of originally.

In some other aspects, following the above, when the tolerance of the first virtual item is less than the auxiliary traction, the following processing may be further performed: Third prompt information is displayed, where the third prompt information is configured for prompting that another virtual item in the virtual scene is selected, and the another virtual item is a virtual item in the virtual scene other than the first virtual item.

Still taking the first virtual item being a virtual tree as an example, when it is detected that the maximum pulling force that the virtual tree can bear is less than the auxiliary traction, that is, there is a risk of breakage of the virtual tree in a process of controlling the virtual vehicle to tighten a virtual traction apparatus (for example, a virtual chain), third prompt information may be displayed, where the third prompt information is configured for prompting a player to select another virtual item in the virtual scene. For example, the third prompt information may include the following text: There is a risk of breakage of a current tree, and please reselect another tree.

In some aspects, the virtual vehicle may be located in a second pothole zone (for example, a small pothole zone in the virtual scene) in the virtual scene, where the second pothole zone is an area in the virtual scene that the virtual vehicle can drive out of based on traction of the virtual vehicle. For example, a slip coefficient (for example, a slip coefficient when a vehicle wheel slips in the second pothole zone) of the virtual vehicle in the second pothole zone is greater than a resistance coefficient of the second pothole zone, so that the virtual vehicle can drive out of the second pothole zone based on the traction of the virtual vehicle. In addition, the foregoing skill release control may be an acceleration control, and the following processing may be further performed: In response to a second trigger operation (for example, a click operation) on the acceleration control, the virtual vehicle is controlled to accelerate, so that the virtual vehicle drives out of a second pothole zone, where the slip coefficient of the virtual vehicle in the second pothole zone is greater than the resistance coefficient of the second pothole zone.

For example, when the virtual vehicle is located in a small pothole zone in the virtual scene, or a small pothole zone exists in front of the virtual vehicle, a player may click the acceleration button. For example, when a click operation (namely a second trigger operation) performed by the player on the acceleration button is received, the virtual vehicle may be controlled to accelerate. Because a slip coefficient of a vehicle wheel is greater than a resistance coefficient of the small pothole zone when the virtual vehicle moves in the small pothole zone, the virtual vehicle may drive out of the small pothole zone, or cross the small pothole zone located in front.

In some aspects, the virtual vehicle may be located in a first pothole zone (for example, a large pothole zone in the virtual scene) in the virtual scene, where the first pothole zone is an area in the virtual scene that the virtual vehicle cannot drive out of based on traction of the virtual vehicle, and the following processing may be further performed: A weight of the virtual vehicle, a slip coefficient of the virtual vehicle in the first pothole zone, and a resistance coefficient of the first pothole zone are obtained; a first result of multiplication of the weight of the virtual vehicle and the slip coefficient and a second result of multiplication of the weight of the virtual vehicle and the resistance coefficient are determined; a result of addition of the first result of multiplication and the auxiliary traction is determined; and in response to that the result of addition is greater than the second result of multiplication, it is determined that the virtual vehicle can drive out of the first pothole zone with the help of the virtual traction apparatus.

For example, when a virtual vehicle is located in a large pothole zone in a virtual scene, or a large pothole zone exists in front of the virtual vehicle, a player may first click an acceleration button to control the virtual vehicle to accelerate forward. When the virtual vehicle still cannot drive out of the large pothole zone after the acceleration, the player may long press the acceleration button, so that the virtual vehicle releases a virtual traction apparatus, thereby providing auxiliary traction for the virtual vehicle. Next, a weight of the virtual vehicle, a slip coefficient when a vehicle wheel of the virtual vehicle (for example, a virtual car) slips in a large pothole zone, and a resistance coefficient of the large pothole zone (where the slip coefficient is less than the resistance coefficient, that is, the virtual vehicle cannot drive out of the large pothole zone based on traction of the virtual vehicle) may be obtained. Subsequently, a first result of multiplication of the weight of the virtual vehicle and the slip coefficient and a second result of multiplication of the weight of the virtual vehicle and the resistance coefficient may be separately calculated, and the first result of multiplication and the auxiliary traction are added, to obtain a result of addition. Finally, the result of addition and the second result of multiplication are compared, and when the result of addition is greater than the second result of multiplication, it is determined that the virtual vehicle can drive out of the large pothole zone with the help of the virtual traction apparatus. For example, an animation that the virtual vehicle drives out of the large pothole zone with the help of the virtual chain may be played.

In some other aspects, following the above, the following processing may be further performed: In response to that the result of addition is less than the second result of multiplication, it is determined that the virtual vehicle still cannot drive out of the first pothole zone with the help of the virtual traction apparatus, and fourth prompt information is displayed, the fourth prompt information being configured for prompting that the virtual vehicle is unable to drive out of the first pothole zone.

For example, following the foregoing example, when it is detected that the result of addition is less than the second result of multiplication, it is determined that the virtual vehicle still cannot drive out of a large pothole zone with the help of the virtual traction apparatus (for example, the virtual chain), and fourth prompt information may be displayed, the fourth prompt information being configured for prompting a player that the virtual vehicle cannot drive out of the large pothole zone. For example, the fourth prompt information may include the following text: The virtual vehicle cannot drive out of a mud pit, and please select another manner to leave the mud pit. For example, the player may control, by clicking a get-off button, the virtual object to leave the virtual vehicle, and control the virtual object to leave the large pothole zone on foot.

In the method for controlling a virtual vehicle according to the aspect described herein, when a player wishes to control the virtual vehicle to release the virtual traction apparatus during driving of the virtual vehicle, the player may reuse an original skill release control in the virtual scene without additionally adding a control, to complete an operation of controlling the virtual vehicle to release the virtual traction apparatus, and auxiliary traction may BE provided for the virtual vehicle through the virtual traction apparatus, so as to help the virtual vehicle drive out of a large pothole or the like in the virtual scene that the virtual vehicle cannot drive out of originally. This improves efficiency of operating the virtual vehicle in the virtual scene, thereby significantly improving operating experience of the player and providing more game fun for the player.

An illustrative application of an aspect described herein in an actual application scene is described below with a massively multiplayer online role-playing game (MMORPG) as an example.

With development of technologies and improvement of performance of mobile devices, an operation direction of a human-computer interaction interface is inevitably to develop more convenient and more efficient control manners, so that a user has a more pleasant human-computer interaction manner. In view of this, an aspect described herein describes a quick grappling operation that may be performed by a virtual vehicle (briefly referred to as a vehicle) in mobile terminal software. For example, in a mobile game, if a player wishes to trigger a grappling operation in a process of driving a vehicle, the player may implement a long press and drag operation by a normal skill attack key (for example, an acceleration button), to complete a grappling operation (for example, an operation of controlling the vehicle to throw a chain) without additionally adding a grapple button. That is, according to the technical solution provided in the aspect described herein, when playing a game, a player can quickly implement a grappling operation with one hand, so that the operation is quick and convenient, and user experience is better.

The following specifically describes the method for controlling a virtual vehicle according to the aspect described herein.

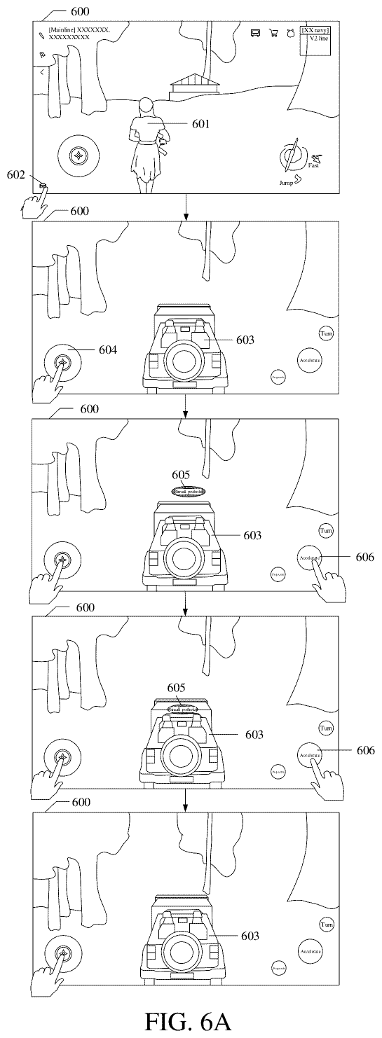

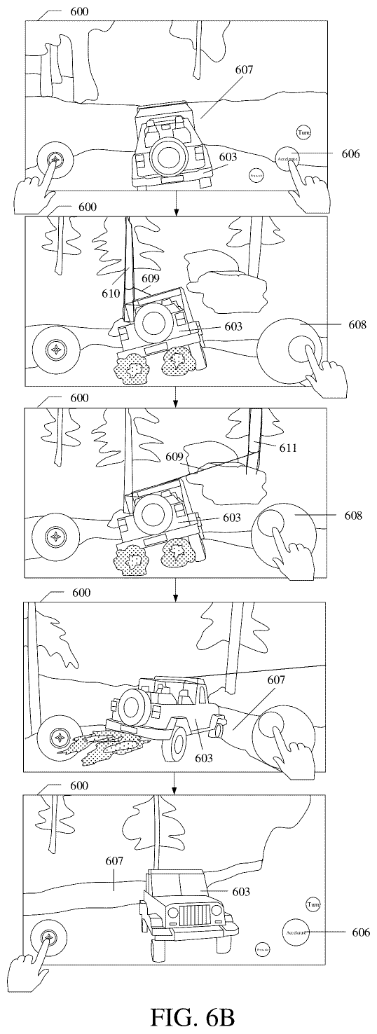

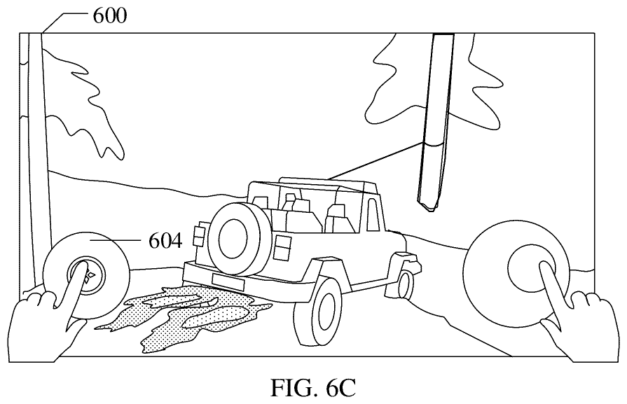

In some aspects, referring to FIG. 6A, FIG. 6A is a schematic diagram of an application scene of a method for controlling a virtual vehicle according to an aspect described herein. As shown in FIG. 6A, when a game is entered, a virtual scene 600 may be displayed on a screen of a terminal device (for example, a mobile phone). A game character 601 controlled by a player and a vehicle button 602 are displayed in the virtual scene 600. When a click operation performed by the player on the vehicle button 602 is received, a virtual vehicle 603 (for example, a virtual car) may be displayed in the virtual scene 600, and the game character 601 may be controlled to enter the virtual vehicle 603, that is, to switch to a vehicle driving mode.

Still referring to FIG. 6A, a joystick button 604 may be further displayed at a lower left corner of the virtual scene 600. The player may operate the joystick button 604 with the left hand to control a motion of the virtual vehicle 603, and for example, may control the virtual vehicle 603 to move forward or move backward in the virtual scene 600 through the joystick button 604. In addition, when encountering a small pothole zone 605 on a road in a process of operating the joystick button 604 to control the virtual vehicle 603 to move forward, the player may click an acceleration button 606 (or referred to as an acceleration key) at a lower right corner, so as to control the virtual vehicle 603 to quickly cross the small pothole zone 605 in the road.

In some other aspects, referring to FIG. 6B, FIG. 6B is a schematic diagram of an application scene of a method for controlling a virtual vehicle according to an aspect described herein. As shown in FIG. 6B, when a player encounters a large pothole zone 607 on a road in a process of controlling a virtual vehicle 603 to move forward through a joystick button, the player may first attempt to click an acceleration button 606. When the virtual vehicle 603 still cannot pass through the large pothole zone 607 after acceleration, the player may long press the acceleration button 606. In this case, the acceleration button 606 is re-presented in a form of a wheel 608. The player may drag the wheel 608, so that the virtual vehicle 603 throws a virtual chain 609 in a direction currently indicated by the wheel 608, to drag any scene item around to which the virtual chain is tied, such as a tree or a stone. For example, when the virtual chain 609 is tied to a tree 610, the tree 610 selected by dragging is highlighted. Certainly, when the player is unsatisfied with the currently selected tree, switching may also be performed by dragging the wheel 608, to select another tree. For example, when a tree 611 in the virtual scene 600 is switched to being selected, the previously selected tree 610 may be restored to an original state, and the currently selected tree 611 is highlighted. When it is detected that the player releases the operation, the virtual vehicle 603 may be controlled to automatically accelerate forward, and the virtual vehicle 603 may be dragged out of the large pothole zone 607 according to a physical pulling force principle. If the virtual vehicle 603 cannot be dragged out of the large pothole zone 607 this time, the player may operate again, and for example, may long press the acceleration button 606 again. In addition, when it is detected that the virtual vehicle 603 crosses the large pothole zone 607, the acceleration button 606 may be restored from a form of the wheel 608 to an original form.

In some aspects, referring to FIG. 6C, FIG. 6C is a schematic diagram of an application scene of a method for controlling a virtual vehicle according to an aspect described herein. As shown in FIG. 6C, in an operation link that a chain mode is triggered by long pressing an acceleration button 606, if a player operates a joystick button 604 with the left hand, a shaking operation on the joystick button 604 changes to an operation of assisting in translating a lens. For example, when the player shakes the joystick button 604 leftward, a virtual lens may be controlled to translate leftward, or when the player shakes the joystick button 604 rightward, the virtual lens may be controlled to translate rightward, so as to help the player check whether there is a tree or a boulder nearby.

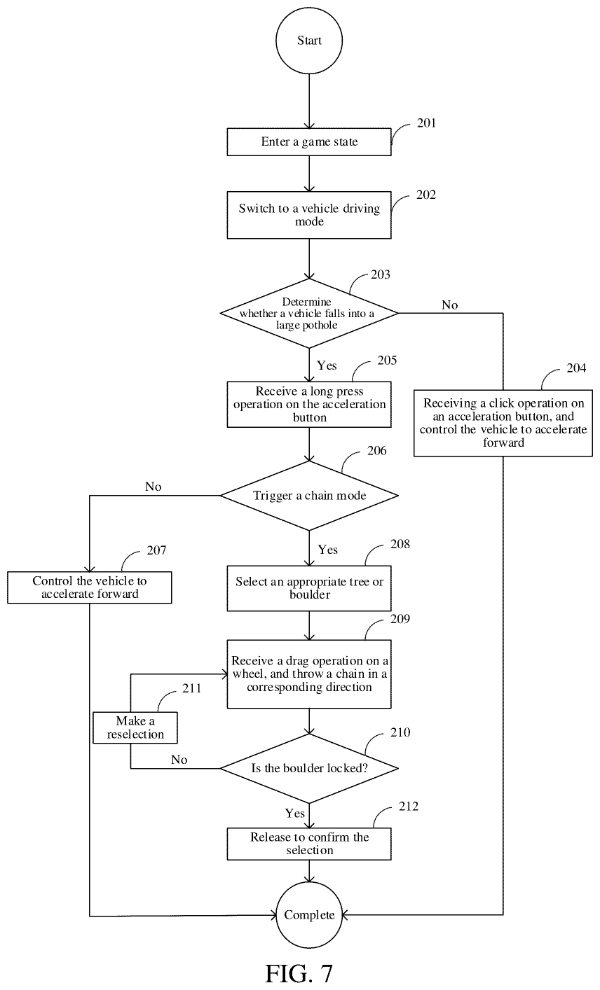

The following continues to describe the method for controlling a virtual vehicle according to the aspect described herein with reference to FIG. 7.

For example, referring to FIG. 7, FIG. 7 is a schematic flowchart of a method for controlling a virtual vehicle according to an aspect described herein. Descriptions are given below with reference to operations shown in FIG. 7.

Operation 201: Enter a game state.

Operation 202: Switch to a vehicle driving mode.

In some aspects, whether the vehicle driving mode is entered may be detected and determined in the following manner: If a player clicks a “get-on” button, a carrier of a character is switched from a ground to a drivable vehicle (the drivable vehicle is briefly referred to as a vehicle below), and a program detects, at each frame, whether a current carrier of the character is a vehicle, and may determine whether the player enters the vehicle driving mode. If the player is in the vehicle driving mode, an interface interaction button is changed to a “get-off” button, and the player may exit the vehicle driving mode by clicking the “get-off” button. In this case, the interaction button enters a normal mode.

Operation 203: Determine whether a vehicle falls into a large pothole, and if not, perform operation 204, or if yes, perform operation 205.

In some aspects, whether the vehicle falls into a large pothole (such as a mud pit) during driving may be detected and determined in the following manner: A flag on whether the vehicle is a mud pit is arranged on a vehicle body. When a game map is made, a movement trigger is added to the mud pit. A mud pit entry notification is triggered when the vehicle moves into the mud pit, and an exit notification is triggered when the vehicle drives out of the mud pit. According to the entry/exit notification, the flag on whether the vehicle is in the mud pit is synchronously modified, and an interface interaction prompt is synchronously triggered. For example, when the vehicle is in the mud pit, it is prompted that the vehicle falls into the pit. When the vehicle exits from the mud pit, it is prompted that the vehicle successfully drives out.

Operation 204: Receiving a click operation on an acceleration button, and control the vehicle to accelerate forward.

Operation 205: Receive a long press operation on the acceleration button.

Operation 206: Determine whether a chain mode is triggered, and if not, perform operation 207, or if yes, perform operation 208.

In some aspects, for a case that the vehicle falls into a mud pit, an aspect described herein provides an auxiliary manner in which the vehicle drives out of the mud pit. For example, in the technical solution provided in the aspect described herein, the vehicle is provided with an independent pulley traction apparatus (namely the foregoing virtual traction apparatus, which is similar to a crane traction apparatus). The pulley traction apparatus is provided with a pull rope (or a chain). One end of the pull rope is connected to the vehicle. The other end of the pull rope is tied to a tree or a boulder, and then the vehicle pulls and tightens the pull rope, so as to provide auxiliary traction for the vehicle.

Operation 207: Control the vehicle to accelerate forward.

Operation 208: Select an appropriate tree or boulder.

Operation 209: Receive a drag operation on a wheel, and throw a chain in a corresponding direction.

Operation 210: Determine whether the boulder is locked, and if not, perform operation 211, or if yes, perform operation 212.

Operation 211: Make a reselection.

Operation 212: Release to confirm the selection.

In some aspects, a formula for the vehicle to escape from a mud pit is designed as follows: A maximum pulling force of a pulley traction apparatus of a vehicle is preset to F_assist_max (namely auxiliary traction), and a formula of total escape traction that needs to be reached for the vehicle to escape from different potholes is set to: F_escape=W (a weight of the vehicle)*zD (a resistance coefficient of the pit). In addition, it is set that when the vehicle moves in the mud pit, a vehicle wheel slips, a slip coefficient (also referred to as a friction coefficient) of the vehicle wheel when the vehicle wheel slips in different potholes is fD, and traction provided by the vehicle wheel in the mud pit is: F_wheel=W (weight of the vehicle)*fD (slip coefficient).

Then, in a mud pit, a maximum total traction obtained by the vehicle with the assistance of the pulley traction apparatus is:

$$F\_total = F\_wheel + F\_assist \_max = W * fD + F\_assist \_max .$$

An escape condition is that the vehicle can escape from the mud pit only when F_total>F_escape. That is:

$$W * fD + F\_assist \_max > W * zD ,$$

where W denotes a vehicle weight, and is preset from different vehicles; F_assist_max denotes a maximum value of auxiliary traction of vehicles, and is preset from different vehicles; fD denotes a slip coefficient of a vehicle wheel in mud pits, and is preset from different mud pits; and zD denotes a resistance coefficient of mud pits, and is preset from different mud pits.

The following continues to describe an escape mode relying only on vehicle wheel power.

In some aspects, it may be detected and determined whether a small pothole zone can be crossed through friction power of a vehicle wheel by relying only on an acceleration function of the vehicle. In this mode, there is no assistance of the pulley traction apparatus of the vehicle, that is, the foregoing auxiliary traction F_assist_max=0, and a condition under which the vehicle escapes from the small pothole zone is:

W*fD>W*zD.

This is equivalent to:

fD>zD.

When a click operation (instead of a long press operation) performed by the player on the acceleration button is received, it may be detected whether the foregoing condition is satisfied, and if the foregoing condition is satisfied, it may be considered that the vehicle can cross the small pothole zone. The foregoing two parameters (namely fD and zD) completely depend on presetting of a pit by a planner, and are irrelevant to the vehicle.

The following continues to describe an escape mode assisted by the pulley traction apparatus.

In some aspects, when encountering a large pothole zone on a road, making it impossible to escape depending only on vehicle wheel power, a player may long press an acceleration button, so that a pull rope of the pulley traction apparatus of the vehicle is thrown, to be locked to a nearest tree or stone (a tree is used as an example for description below), and a chain mode (or referred to as an auxiliary mode) is entered. In the auxiliary mode, after the player releases the acceleration button, auxiliary traction is released. That is, the foregoing auxiliary traction F_assist_max>0, and a condition under which the vehicle escapes from a large pothole zone is:

$$W * fD + F\_assist \_max > W * zD .$$

In addition, it is detected whether the foregoing condition is satisfied, and if yes, it may be considered that the vehicle can cross the large pothole zone in the auxiliary mode. The foregoing four parameters depend entirely on presetting of a pit and presetting of a vehicle by a planner. In addition, when the foregoing condition is not satisfied, the player can exit the vehicle driving mode only, and controls a character to walk out of the large pothole zone.

In some other aspects, because different trees can bear different pulling forces, before the foregoing escape condition is detected, a tolerance of a tree may be further preferentially detected. According to a pulling force interaction principle, a pulling force on a tree (for example, a trunk of the tree) is equal to auxiliary traction F_assist_max of the pulley traction apparatus of the vehicle. In addition, it is assumed that a preset maximum pulling force that the tree can bear is F_tree, when F_assist_max>F_tree, the trunk is broken, and as a result, the vehicle retracts the pull rope and exits the auxiliary mode. In this case, the player may long press the acceleration button again to select a next closest tree to enter the chain mode again. Detection of the foregoing escape condition is entered only when the tolerance F_tree of the trunk of the next tree>F_assist_max.

To sum up, in the auxiliary mode, determining and detection of vehicle escape is completed in the following:
(1) F_tree>F_assist_max, that is, a locked tree needs to have a sufficient tolerance, otherwise, a tree needs to replace the locked tree and be relocked.
(2) W*fD+F_assist_max>W*zD, that is, a sum of a friction force provided by a vehicle wheel of the vehicle and auxiliary traction needs to be greater than pit exit resistance.

In some aspects, whether an operation on the joystick button may be switched to a lens translation observation operation in the auxiliary mode may be detected and determined according to whether the acceleration button enters a long press state. For example, after collecting event data, a processor may determine whether an operation is a long press operation or a click operation according to a gesture action. A control unit executes a corresponding operation after receiving a processing result of the processor.

To sum up, the method for controlling a virtual vehicle according to the aspect described herein has the following beneficial effects: The technical solution provided in the aspect described herein is widely applied to such games in which operation efficiency needs to be improved. By quick and efficient completion of an operation that originally needs a plurality of operations to be implemented, operation experience of a player can be significantly improved, thereby providing more game fun for the player.

The following continues to describe an illustrative structure in which the apparatus 555 for controlling a virtual vehicle according to the aspect described herein is implemented as software modules. In some aspects, as shown in FIG. 2, the software modules of the apparatus 555 for controlling a virtual vehicle that is stored in the memory 550 may include: a display module 5551 and a control module 5552.

The display module 5551 is configured to display a virtual scene, the virtual scene including a virtual vehicle and a skill release control, the skill release control being associated with a plurality of skills, and different skills being triggered in different manners; the control module 5552 is configured to control the virtual vehicle to release a virtual traction apparatus in response to a first trigger operation on the skill release control, one end of the virtual traction apparatus being connected to the virtual vehicle; and the control module 5552 is further configured to control, in response to that the other end of the virtual traction apparatus is connected to a first virtual item in the virtual scene, the virtual vehicle to tighten the virtual traction apparatus, to provide auxiliary traction for the virtual vehicle.

In some aspects, the first trigger operation includes a press operation; the apparatus 555 for controlling a virtual vehicle further includes a switching module 5553, configured to switch the skill release control to a wheel control in response to the press operation on the skill release control; and the control module 5552 is further configured to control the virtual vehicle to release the virtual traction apparatus in a first direction in the virtual scene in response to a drag operation on the wheel control, the first direction being a direction indicated by the wheel control when the drag operation is released.

In some aspects, the virtual vehicle is located in a first pothole zone in the virtual scene, where the first pothole zone is an area in the virtual scene that the virtual vehicle cannot drive out of based on traction of the virtual vehicle; and the switching module 5553 is further configured to switch the wheel control back to the skill release control in response to that the virtual vehicle drives out of the first pothole zone with the help of the virtual traction apparatus.

In some aspects, the display module 5551 is further configured to display first prompt information in response to that the virtual vehicle drives into the first pothole zone, the first prompt information being configured for prompting that the virtual vehicle falls into the first pothole zone, and is configured to display second prompt information in response to that the virtual vehicle drives out of the first pothole zone with the help of the virtual traction apparatus, the second prompt information being configured for prompting that the virtual vehicle successfully drives out of the first pothole zone.

In some aspects, the virtual scene further includes a joystick control; and after the switching module 5553 switches the skill release control to the wheel control, the control module 5552 is further configured to control, in response to a shaking operation on the joystick control, a virtual lens in the virtual scene to translate in a shaking direction of the shaking operation.

In some aspects, the first trigger operation includes a press operation; and the control module 5552 is further configured to control the virtual vehicle to release the virtual traction apparatus in a second direction in the virtual scene in response to the press operation on the skill release control, the second direction including one of the following: a current driving direction of the virtual vehicle, a direction pointing from the virtual vehicle to a closest virtual item, and a direction pointing from the virtual vehicle to a virtual item with a maximum tolerance.

In some aspects, the first trigger operation includes a press operation; the display module 5551 is further configured to highlight, in response to the press operation on the skill release control, a plurality of virtual items in the virtual scene that are within a connection range of the virtual traction apparatus; and the control module 5552 is further configured to control the virtual vehicle to release the virtual traction apparatus to a selected virtual item in response to a selection operation on the plurality of virtual items.

In some aspects, the first trigger operation includes a press operation, and the skill release control includes an acceleration control; the apparatus 555 for controlling a virtual vehicle further includes an obtaining module 5554 and a prediction module 5555, where the obtaining module 5554 is configured to obtaining, in response to the press operation on the acceleration control, a plurality of virtual items in the virtual scene that are within a connection range of the virtual traction apparatus; the prediction module 5555 is configured to invoke a machine learning model for prediction based on feature information corresponding to the plurality of virtual items respectively, to obtain probabilities of being selected that correspond to the virtual items respectively; and the control module 5552 is further configured to control the virtual vehicle to release the virtual traction apparatus to a virtual item with a maximum probability of being selected.

In some aspects, the display module 5551 is further configured to highlight a first virtual item in the virtual scene in response to that the other end of the virtual traction apparatus is connected to the first virtual item; and restore the first virtual item to a default display style and highlight a second virtual item in the virtual scene, in response to that the other end of the virtual traction apparatus is switched to being connected to the second virtual item.

In some aspects, before the control module 5552 controls the virtual vehicle to tighten the virtual traction apparatus, the obtaining module 5554 is further configured to obtain a tolerance of the first virtual item; and the apparatus 555 for controlling a virtual vehicle further includes a transition module 5556, configured to switch, in response to that the tolerance is greater than or equal to the auxiliary traction, to executing the process of controlling the virtual vehicle to tighten the virtual traction apparatus.

In some aspects, the display module 5551 is further configured to display third prompt information in response to that the tolerance is less than the auxiliary traction, the third prompt information being configured for prompting that another virtual item in the virtual scene is selected, and the another virtual item being a virtual item in the virtual scene other than the first virtual item.

In some aspects, the virtual vehicle is located in a second pothole zone in the virtual scene, the second pothole zone is an area in the virtual scene that the virtual vehicle can drive out of based on traction of the virtual vehicle, and the skill release control includes an acceleration control; and the control module 5552 is further configured to control, in response to a second trigger operation on the acceleration control, the virtual vehicle to accelerate, so that the virtual vehicle drives out of the second pothole zone, a slip coefficient of the virtual vehicle in the second pothole zone being greater than a resistance coefficient of the second pothole zone.

In some aspects, the virtual vehicle is located in a first pothole zone in the virtual scene, where the first pothole zone is an area in the virtual scene that the virtual vehicle cannot drive out of based on traction of the virtual vehicle; the obtaining module 5554 is further configured to obtain a weight of the virtual vehicle, a slip coefficient of the virtual vehicle in the first pothole zone, and a resistance coefficient of the first pothole zone; the apparatus 555 for controlling a virtual vehicle further includes a determining module 5557, configured to determine a first result of multiplication of the weight of the virtual vehicle and the slip coefficient and a second result of multiplication of the weight of the virtual vehicle and the resistance coefficient, and configured to determine a result of addition of the first result of multiplication and the auxiliary traction; and the determining module 5557 is further configured to determine, in response to that the result of addition is greater than the second result of multiplication, that the virtual vehicle can drive out of the first pothole zone with the help of the virtual traction apparatus.

In some aspects, the determining module 5557 is further configured to determine, in response to that the result of addition is less than the second result of multiplication, that the virtual vehicle still cannot drive out of the first pothole zone with the help of the virtual traction apparatus; and the display module 5551 is further configured to display fourth prompt information, the fourth prompt information being configured for prompting that the virtual vehicle is unable to drive out of the first pothole zone.

In some aspects, the display module 5551 is further configured to display a virtual scene, the virtual scene including a virtual object and a vehicle control, and display a virtual vehicle and a skill release control in the virtual scene in response to a trigger operation on the vehicle control; and the control module 5552 is further configured to control the virtual object to enter the virtual vehicle.

Descriptions of the apparatus according to the aspect described herein are similar to the descriptions of the foregoing method aspect. The apparatus has beneficial effects similar to those of the method aspect, and therefore details are not described. Technical details that are not completed in the apparatus for controlling a virtual vehicle according to the aspect described herein may be understood according to descriptions in any one of FIG. 3, FIG. 4, or FIG. 5.

An aspect described herein provides a computer program product, the computer program product including a computer program or computer-executable instructions, and the computer program or the computer-executable instructions being stored in a computer-readable storage medium. A processor of a computer device reads the computer-executable instructions from the computer-readable storage medium, and the processor executes the computer-executable instructions, to cause the computer device to perform the foregoing method for controlling a virtual vehicle according to the aspect described herein.

An aspect described herein provides a computer-readable storage medium, having computer-executable instructions stored therein, the computer-executable instructions, when executed by a processor, causing the processor to perform the method for controlling a virtual vehicle according to the aspect described herein, for example, the method for controlling a virtual vehicle shown in FIG. 3, FIG. 4, or FIG. 5.

In some aspects, the computer-readable storage medium may be a memory such as a ferroelectric random access memory (FRAM), an ROM, a programmable read-only memory (PROM), an electrically programmable read-only memory (EPROM), an electrically erasable programmable read-only memory (EEPROM), a flash memory, a magnetic surface memory, an optical disc, or a compact disc read-only memory (CD-ROM), or may be various devices including one of the foregoing memories or any combination thereof.

In some aspects, the executable instructions may be written in a form of a program, software, a software module, a script, or code and according to a programming language (including a compiled or interpretive language or a declarative or procedural language) in any form, and may be deployed in any form, including an independent program or a module, a component, a subroutine, or another unit suitable for use in a computing environment.

In an example, the executable instructions may be deployed to be executed on one electronic device, or deployed to be executed on a plurality of electronic devices at one location, or deployed to be executed on a plurality of electronic devices that are distributed in a plurality of locations and interconnected by a communication network.

The foregoing descriptions are merely aspects described herein, and are not intended to limit the protection scope described herein. Any modification, equivalent replacement, improvement, and the like made within the spirit and scope described herein shall fall within the protection scope described herein.

What is claimed is:

1. A computer-implemented method, comprising:
displaying a virtual scene, the virtual scene comprising a virtual vehicle and a skill release control, the skill release control being associated with a plurality of skills, wherein each of the different skills is associated with a different trigger operation;
controlling the virtual vehicle to release a virtual traction apparatus in response to a first trigger operation on the skill release control, one end of the virtual traction apparatus being connected to the virtual vehicle; and
controlling, in response to the other end of the virtual traction apparatus being connected to a first virtual item in the virtual scene, the virtual vehicle to tighten the virtual traction apparatus, to provide auxiliary traction for the virtual vehicle.

2. The method according to claim 1, wherein:
the first trigger operation comprises a press operation; and
the controlling the virtual vehicle to release a virtual traction apparatus in response to a first trigger operation on the skill release control comprises:
switching the skill release control to a wheel control in response to the press operation on the skill release control; and
controlling the virtual vehicle to release the virtual traction apparatus in a first direction in the virtual scene in response to a drag operation on the wheel control, the first direction being a direction indicated by the wheel control when the drag operation is released.

3. The method according to claim 2, wherein:
the virtual vehicle is located in a pothole zone in the virtual scene, wherein the pothole zone is an area in the virtual scene that the virtual vehicle is unable to drive out of based on traction of the virtual vehicle; and
the method further comprises:
switching the wheel control back to the skill release control in response to the virtual vehicle exiting the pothole zone with the help of the virtual traction apparatus.

4. The method according to claim 3, further comprising:
displaying first prompt information in response to the virtual vehicle entering the pothole zone, the first prompt information being configured for prompting that the virtual vehicle falls into the pothole zone; and
displaying second prompt information in response to the virtual vehicle exiting out of the pothole zone with the help of the virtual traction apparatus, the second prompt information being configured for prompting that the virtual vehicle successfully drives out of the pothole zone.

5. The method according to claim 2, wherein:
the virtual scene further comprises a joystick control; and
after the switching the skill release control to a wheel control, the method further comprises:
controlling, in response to a shaking operation on the joystick control, a virtual lens in the virtual scene to translate in a shaking direction of the shaking operation.

6. The method according to claim 1, wherein:
the first trigger operation comprises a press operation; and
the controlling the virtual vehicle to release the virtual traction apparatus comprises:
controlling the virtual vehicle to release the virtual traction apparatus in a second direction in the virtual scene in response to the press operation on the skill release control, the second direction comprising one of the following: a current driving direction of the virtual vehicle, a direction pointing from the virtual vehicle to a closest virtual item, and a direction pointing from the virtual vehicle to a virtual item with a maximum tolerance.

7. The method according to claim 1, wherein:
the first trigger operation comprises a press operation; and
the controlling the virtual vehicle to release a virtual traction apparatus comprises:
highlighting, in response to the press operation on the skill release control, a plurality of virtual items in the virtual scene that are within a connection range of the virtual traction apparatus; and
controlling the virtual vehicle to release the virtual traction apparatus to a selected virtual item in response to a selection operation on the plurality of virtual items.

8. The method according to claim 1, wherein:
the first trigger operation comprises a press operation, and the skill release control comprises an acceleration control; and
the controlling the virtual vehicle to release a virtual traction apparatus in response to a first trigger operation on the skill release control comprises:
obtaining, in response to the press operation on the acceleration control, a plurality of virtual items in the virtual scene that are within a connection range of the virtual traction apparatus;
invoking a machine learning model for prediction based on feature information corresponding to the plurality of virtual items respectively, to obtain probabilities of being selected that correspond to the virtual items respectively; and
controlling the virtual vehicle to release the virtual traction apparatus to a virtual item with a maximum probability of being selected.

9. The method according to claim 8, wherein before the invoking a machine learning model for prediction, the method further comprises:
obtaining a sample virtual item pre-marked with a probability of being selected;
invoking an initialized machine learning model for prediction based on feature information of the sample virtual item, to obtain a prediction result; and
determining a difference between the prediction result and the pre-marked probability of being selected, performing back propagation based on the difference, and updating parameters of the machine learning model layer by layer in a backpropagation process.

10. The method of claim 1, wherein in response to that the other end of the virtual traction apparatus is connected to a first virtual item in the virtual scene, the method further comprises:
highlighting the first virtual item; and
restoring the first virtual item to a default display style and highlighting a second virtual item in the virtual scene, in response to that the other end of the virtual traction apparatus is switched to being connected to the second virtual item.

11. The method of claim 1, wherein before the controlling the virtual vehicle to tighten the virtual traction apparatus, the method further comprises:
obtaining a tolerance of the first virtual item; and
switching, in response to that the tolerance is greater than or equal to the auxiliary traction, to executing the process of controlling the virtual vehicle to tighten the virtual traction apparatus.

12. The method according to claim 11, further comprising:
displaying third prompt information in response to that the tolerance is less than the auxiliary traction, the third prompt information being configured for prompting that another virtual item in the virtual scene is selected, and the another virtual item being a virtual item in the virtual scene other than the first virtual item.

13. The method of claim 1, wherein:
the virtual vehicle is located in a pothole zone in the virtual scene, the pothole zone being an area in the virtual scene that the virtual vehicle is able to drive out of based on traction of the virtual vehicle, and the skill release control comprises an acceleration control; and
the method further comprises:
controlling, in response to a second trigger operation on the acceleration control, the virtual vehicle to accelerate, so that the virtual vehicle drives out of the pothole zone, a slip coefficient of the virtual vehicle in the pothole zone being greater than a resistance coefficient of the pothole zone.

14. The method of claim 1, wherein
the virtual vehicle is located in a pothole zone in the virtual scene, wherein the pothole zone is an area in the virtual scene that the virtual vehicle is unable to drive out of based on traction of the virtual vehicle; and
the method further comprises:
obtaining a weight of the virtual vehicle, a slip coefficient of the virtual vehicle in the pothole zone, and a resistance coefficient of the pothole zone;
multiplying the weight of the virtual vehicle and the slip coefficient;
multiplying the weight of the virtual vehicle and the resistance coefficient;
adding the first result of multiplication with the auxiliary traction; and
when the addition is greater than the second result of multiplication, determining that the virtual vehicle is able to drive out of the pothole zone with the help of the virtual traction apparatus.

15. The method according to claim 14, further comprising:
determining, when the addition is less than the second result of multiplication, that the virtual vehicle is still unable to drive out of the pothole zone with the help of the virtual traction apparatus, and displaying fourth prompt information, the fourth prompt information being configured for prompting that the virtual vehicle is unable to drive out of the pothole zone.

16. The method of claim 1, wherein the displaying a virtual scene comprises:
displaying the virtual scene, the virtual scene comprising a virtual character and a vehicle control; and
displaying the virtual vehicle and the skill release control in the virtual scene, and controlling the virtual character to enter the virtual vehicle, in response to a trigger operation on the vehicle control.

17. One or more non-transitory computer readable media comprising computer readable instructions that, when executed by a processor, configure a data processing system to perform:
displaying a virtual scene, the virtual scene comprising a virtual vehicle and a skill release control, the skill release control being associated with a plurality of skills, wherein each of the different skills is associated with a different trigger operation;
controlling the virtual vehicle to release a virtual traction apparatus in response to a first trigger operation on the skill release control, one end of the virtual traction apparatus being connected to the virtual vehicle; and
controlling, in response to the other end of the virtual traction apparatus being connected to a first virtual item in the virtual scene, the virtual vehicle to tighten the virtual traction apparatus, to provide auxiliary traction for the virtual vehicle.

18. The computer readable media of claim 17, wherein:
the first trigger operation comprises a press operation, and the skill release control comprises an acceleration control; and
the controlling the virtual vehicle to release a virtual traction apparatus in response to a first trigger operation on the skill release control comprises:
obtaining, in response to the press operation on the acceleration control, a plurality of virtual items in the virtual scene that are within a connection range of the virtual traction apparatus;
invoking a machine learning model for prediction based on feature information corresponding to the plurality of virtual items respectively, to obtain probabilities of being selected that correspond to the virtual items respectively; and
controlling the virtual vehicle to release the virtual traction apparatus to a virtual item with a maximum probability of being selected.

19. The computer readable media of claim 18, wherein before the invoking a machine learning model for prediction:
obtaining a sample virtual item pre-marked with a probability of being selected;
invoking an initialized machine learning model for prediction based on feature information of the sample virtual item, to obtain a prediction result; and
determining a difference between the prediction result and the pre-marked probability of being selected, performing back propagation based on the difference, and updating parameters of the machine learning model layer by layer in a backpropagation process.

20. A system comprising: a processor, and memory storing computer readable instructions that, when executed by the processor, configure the system to perform:
displaying a virtual scene, the virtual scene comprising a virtual vehicle and a skill release control, the skill release control being associated with a plurality of skills, wherein each of the different skills is associated with a different trigger operation;
controlling the virtual vehicle to release a virtual traction apparatus in response to a first trigger operation on the skill release control, one end of the virtual traction apparatus being connected to the virtual vehicle; and
controlling, in response to the other end of the virtual traction apparatus being connected to a first virtual item in the virtual scene, the virtual vehicle to tighten the virtual traction apparatus, to provide auxiliary traction for the virtual vehicle.
